(19) United States
(12) Patent Application Publication
(10) Pub. No.: US 2022/0075809 A1
(43) Pub. Date: Mar. 10, 2022

(54) BOOTSTRAPPING OF TEXT CLASSIFIERS

(71) Applicant: INTERNATIONAL BUSINESS MACHINES CORPORATION, ARMONK, NY (US)

(72) Inventors: Francesco Fusco, Zurich (CH); Mattia Atzeni, Zurich (CH); Abderrahim Labbi, Gattikon (CH)

(21) Appl. No.: 16/948,247

(22) Filed: Sep. 10, 2020

(51) Int. Cl. G06F 16/35; G06F 9/4401; G06F 16/31; G06N 20/00; G06N 5/00

(52) U.S. Cl. CPC G06F 16/353; G06F 9/4401; G06N 5/003; G06N 20/00; G06F 16/31

(57) ABSTRACT

Computer-implemented methods and systems are provided for generating training datasets for bootstrapping text classifiers. Such a method includes providing a word embedding matrix. This matrix is generated from a text corpus by encoding words in the text as respective tokens such that selected compound keywords in the text are encoded as single tokens. The method includes receiving, via a user interface, a user-selected set of the keywords a nearest neighbor search of the embedding space is performed for each keyword in the set to identify neighboring keywords, and a plurality of the neighboring keywords are added to the keyword-set. The method further comprises, for a corpus of documents, string-matching keywords in the keyword-sets to text in each document to identify, based on results of the string-matching, documents associated with each text class. The documents identified for each text class are stored as the training dataset for the classifier.

### BACKGROUND

The present invention relates generally to bootstrapping of text classifiers. Computer-implemented methods are provided for generating training datasets for bootstrapping text classifiers, together with systems employing such methods.

Text classification involves assigning documents or other text samples to classes according to their content. Machine learning models can be trained to perform text classification via a supervised learning process. The training process uses a dataset of text samples for which the correct class labels (ground truth labels) are known. Training samples are supplied to the model in an iterative process in which the model output is compared with the ground truth label for each sample to obtain an error signal which is used to update the model parameters. The parameters are thus progressively updated as the model “learns” from the labelled training data. The resulting trained model can then be applied for inference to classify new (previously unseen) text samples.

Training models for accurate text classification requires a large training dataset with high-quality labels. Typically, training samples are labelled by human annotators for initial training of a model, and the model may then be retrained as additional labelled samples become available, e.g. by collecting feedback from model-users. Generating sufficiently large, accurately labelled datasets is a hugely time-intensive process, involving significant effort by human annotators with expertise in the appropriate fields. For complex technology and other specialized fields, obtaining expert input to generate sufficient ground truth data for initial model training can be extremely, even prohibitively, expensive. An effective technique for bootstrapping text classifiers when no ground truth data is available would be highly desirable.

### BRIEF SUMMARY

Additional aspects and/or advantages will be set forth in part in the description which follows and, in part, will be apparent from the description, or may be learned by practice of the invention.

One aspect of the present invention provides a computer-implemented method for generating a training dataset for bootstrapping a text classifier. The method includes providing a word embedding matrix. This matrix is generated from a text corpus by encoding words in the text as respective tokens such that selected compound keywords in the text are encoded as single tokens and processing the encoded text via a word embedding scheme to generate the word embedding matrix. The resulting matrix comprises a set of vectors each indicating location of a respective token in an embedding space. The method includes receiving, via a user interface, a user-selected set of the keywords which are associated with each text class to be classified by the classifier. For each keyword-set, a nearest neighbor search of the embedding space is performed for each keyword in the set to identify neighboring keywords, and a plurality of the neighboring keywords are added to the keyword-set. The method further comprises, for a corpus of documents, string-matching keywords in the keyword-sets to text in each document to identify, based on results of the string-matching, documents associated with each text class. The documents identified for each text class are stored as the training dataset for the classifier.

Methods embodying the invention enable automatic generation of training datasets for bootstrapping text classifiers with only minimal, easily obtainable, user input. Users are not required to provide text samples for each class, but only to input a (relatively small) set of compound keywords associated with each class. The compound keywords (which are inherently less ambiguous than single words—e.g. “power plant” is less ambiguous than “plant) are represented by single tokens (so effectively treated as single words) in the word embedding space. A nearest-neighbor search of the embedding space, with each keyword used as a seed, allows a small user-selected keyword-set to be expanded into a meaningful dictionary, with entries of limited-ambiguity, which is overall descriptive of each class. Simple string-matching of the resulting, expanded keyword-sets in a document corpus can then provide a training dataset of sufficient accuracy to bootstrap a text classifier. With this technique, embodiments of the invention enable effective automation of a training set generation process which previously required significant manual effort by expert annotators.

Compound keywords selected for the word embedding scheme may include closed compound words, hyphenated compound words, and open compound words or plural-word phrases/multiword expressions. A given “compound keyword” may thus comprise a single word or a plurality of words which, collectively as a group, convey a particular meaning as a semantic unit. Such compound keywords carry less ambiguities than individual words and can be collected for the word embedding process with comparative ease. Preferred methods include the step of obtaining these compound keywords by processing a knowledge base to extract compound keywords associated with hyperlinks. In knowledge bases such as Wikipedia, for instance, hyperlinks are manually annotated and therefore of high quality, providing a ready source of easily identifiable keywords for use in methods embodying the invention.

The word embedding matrix may be prestored in the system, for use in generating multiple datasets, or may be generated and stored as a preliminary step of a particular dataset generation process. To produce the word embedding matrix, when processing the encoded text via the word embedding scheme, preferred methods generate an initial embedding matrix which includes a vector corresponding to each token in the encoded text. Vectors which do not correspond to tokens for compound keywords are then removed from this initial matrix to obtain the final word embedding matrix. This “filtered” matrix, relating specifically to keyword-tokens, reduces complexity of the subsequent search process while exploiting context information from other words in the text corpus to generate the embedding.

In preferred embodiments, the nearest neighbor search of the embedding space for each keyword comprises a breadth-first k-nearest neighbor search over a graph which is generated by locating k neighboring tokens in the embedding space to the token corresponding to that keyword, and iteratively locating neighboring tokens to each token so located. For a given keyword, the neighboring keywords comprise keywords corresponding to tokens so located within a predefined scope for the search. This predefined scope may comprise constraints on one or more search parameters, e.g. at least one (and preferably both) of a predefined maximum depth in the graph and a predefined maximum distance in the embedding space for locating neighboring tokens. This provides an efficient search process in which the drift between the discovered neighboring keywords and the original seed keyword can be controlled to achieve a desired trade-off between precision and recall. Clustering information may also be used to further refine the search. Methods may include clustering tokens in the embedding space, and the predefined scope of the search for each keyword may include a restriction to tokens in the same cluster as the token corresponding to that keyword.

Some or all neighboring tokens located by the searches may be added to the keyword-sets. In preferred embodiments, however, any neighboring keyword which is identified for more than one keyword-set is excluded from the keywords added to the keyword-sets. This eliminates keywords which are potentially non-discriminative, improving quality of the resulting dataset.

When string-matching the resulting keywords in the document corpus, preferred embodiments identify a document as associated with a text class if: any of the keywords in the keyword-set associated with that class are longest-string matched to text in the document; and no keyword in a keyword-set associated with another class is longest-string matched to the text in the document. Longest-string matching requires that the entire keyword is matched, ensuring maximum specificity in the matching process. This process also ignores documents matched to keywords in more than one keyword set which might otherwise blur class distinctions in the resulting classifier.

Respective further aspects of the invention provide a system which is adapted to implement a method for generating a training dataset as described above, and a computer program product comprising a computer readable storage medium embodying program instructions, executable by a processing apparatus, to cause the processing apparatus to implement such a method.

Embodiments of the invention will be described in more detail below, by way of illustrative and non-limiting example, with reference to the accompanying drawings.

### BRIEF DESCRIPTION OF THE DRAWINGS

The above and other aspects, features, and advantages of certain exemplary embodiments of the present invention will be more apparent from the following description taken in conjunction with the accompanying drawings, in which:

FIG. 1 is a schematic representation of a computing system for implementing methods embodying the invention.

FIG. 2 illustrates component modules of a dataset generation system embodying the invention.

FIG. 3 indicates preliminary steps performed by the FIG. 2 system to generate a word embedding matrix.

FIG. 4 indicates steps of a dataset generation process in the FIG. 2 system.

FIG. 5 illustrates a nearest-neighbor search operation in an embodiment of the system.

FIG. 6 indicates steps involved in processing a document corpus in an embodiment of the system.

FIG. 7 illustrates a graphical user interface provided in an embodiment of the system.

### DETAILED DESCRIPTION

The following description with reference to the accompanying drawings is provided to assist in a comprehensive understanding of exemplary embodiments of the invention as defined by the claims and their equivalents. It includes various specific details to assist in that understanding but these are to be regarded as merely exemplary. Accordingly, those of ordinary skill in the art will recognize that various changes and modifications of the embodiments described herein can be made without departing from the scope and spirit of the invention. In addition, descriptions of well-known functions and constructions may be omitted for clarity and conciseness.

The terms and words used in the following description and claims are not limited to the bibliographical meanings, but, are merely used to enable a clear and consistent understanding of the invention. Accordingly, it should be apparent to those skilled in the art that the following description of exemplary embodiments of the present invention is provided for illustration purpose only and not for the purpose of limiting the invention as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces unless the context clearly dictates otherwise.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

Embodiments to be described can be performed as computer-implemented methods for generating training datasets for bootstrapping text classifiers. The methods may be implemented by a computing system comprising one or more general- or special-purpose computers, each of which may comprise one or more (real or virtual) machines, providing functionality for implementing the operations described herein. Steps of methods embodying the invention may be implemented by program instructions, e.g. program modules, implemented by a processing apparatus of the system. Generally, program modules may include routines, programs, objects, components, logic, data structures, and so on that perform particular tasks or implement particular abstract data types. The computing system may be implemented in a distributed computing environment, such as a cloud computing environment, where tasks are performed by remote processing devices that are linked through a communications network. In a distributed computing environment, program modules may be located in both local and remote computer system storage media including memory storage devices.

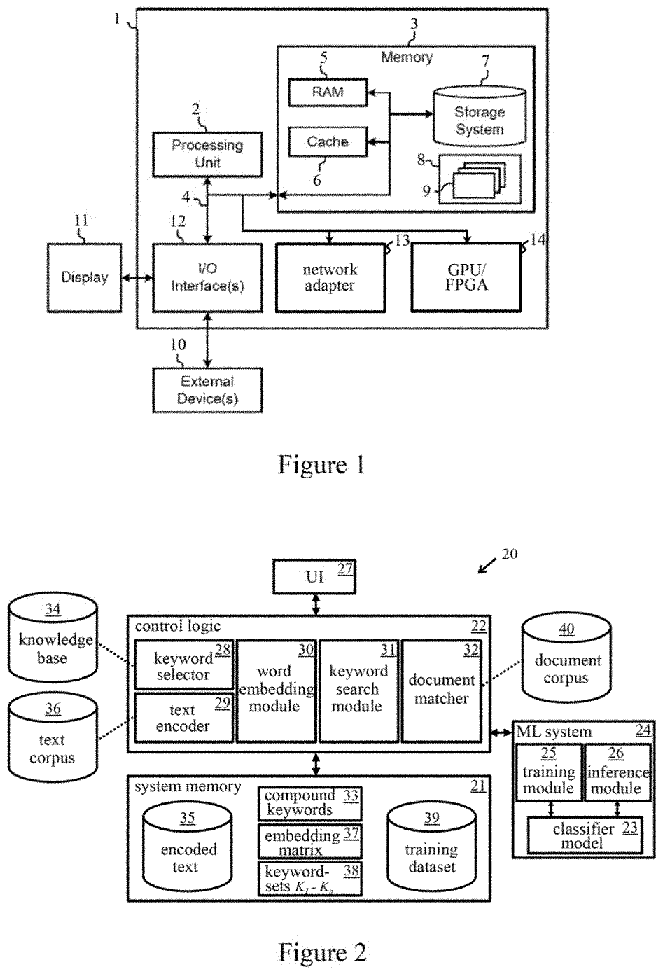

FIG. 1 is a block diagram of exemplary computing apparatus for implementing methods embodying the invention. The computing apparatus is shown in the form of a general-purpose computer 1. The components of computer 1 may include processing apparatus such as one or more processors represented by processing unit 2, a system memory 3, and a bus 4 that couples various system components including system memory 3 to processing unit 2.

Bus 4 represents one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus.

Computer 1 typically includes a variety of computer readable media. Such media may be any available media that is accessible by computer 1 including volatile and non-volatile media, and removable and non-removable media. For example, system memory 3 can include computer readable media in the form of volatile memory, such as random-access memory (RAM) 5 and/or cache memory 6. Computer 1 may further include other removable/non-removable, volatile/non-volatile computer system storage media. By way of example only, storage system 7 can be provided for reading from and writing to a non-removable, non-volatile magnetic medium (commonly called a “hard drive”). Although not shown, a magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM or other optical media can also be provided. In such instances, each can be connected to bus 13 by one or more data media interfaces.

Memory 3 may include at least one program product having one or more program modules that are configured to carry out functions of embodiments of the invention. By way of example, program/utility 8, having a set (at least one) of program modules 9, may be stored in memory 3, as well as an operating system, one or more application programs, other program modules, and program data. Each of the operating system, one or more application programs, other program modules, and program data, or some combination thereof, may include an implementation of a networking environment. Program modules 9 generally carry out the functions and/or methodologies of embodiments of the invention as described herein.

Computer 1 may also communicate with: one or more external devices 10 such as a keyboard, a pointing device, a display 11, etc.; one or more devices that enable a user to interact with computer 1; and/or any devices (e.g., network card, modem, etc.) that enable computer 1 to communicate with one or more other computing devices. Such communication can occur via Input/Output (I/O) interfaces 12. Also, computer 1 can communicate with one or more networks such as a local area network (LAN), a general wide area network (WAN), and/or a public network (e.g., the Internet) via network adapter 13. As depicted, network adapter 13 communicates with the other components of computer 1 via bus 4. Computer 1 may also communicate with additional processing apparatus 14, such as a GPU (graphics processing unit) or FPGA, for implementing embodiments of the invention. It should be understood that although not shown, other hardware and/or software components could be used in conjunction with computer 1. Examples include, but are not limited to: microcode, device drivers, redundant processing units, external disk drive arrays, RAID systems, tape drives, and data archival storage systems, etc.

The FIG. 2 schematic illustrates component modules of a dataset generation system implementing methods embodying the invention. The system 20 comprises memory 21 and control logic, indicated generally at 22, comprising functionality for generating a training dataset for a text classifier. The text classifier itself can be implemented by a machine learning (ML) model 23 in a base ML system 24. The base ML system, including a training module 25 and an inference module 26, may be local or remote from system 20 and may be integrated with the system in some embodiments. A user interface (UI) 27 provides for interaction between control logic 22 and system users during the dataset generation process. UI 27 is conveniently implemented as a graphical user interface (GUI) which is adapted to prompt and assist a user providing inputs for the dataset generation process.

The control logic 22 comprises a keyword selector module 28, a text encoder module 29, a word embedding module 30, a keyword search module 31 and a document matcher module 32. Each of these modules comprises functionality for implementing particular steps of the dataset generation process detailed below. These modules interface with memory 21 which stores various data structures generated in operation of system 20. These data structures comprise a list of compound keywords 33 which are extracted by keyword selector 28 from a knowledge base indicated schematically at 34, and an encoded text-set 35 which is generated by text encoder 29 from a text corpus indicated schematically at 36. Memory 21 also stores a word embedding matrix 37 which is generated by embedding module 30, and plurality 38 of keyword sets Ki, i=1 to n, one for each of the n text classes to be classified by model 23. The final training dataset 39, generated by document matcher 32 from a document corpus indicated schematically at 40, is also stored in system memory 21.

In general, functionality of control logic modules 28 through 32 may be implemented by software (e.g., program modules) or hardware or a combination thereof. Functionality detailed below may be allocated differently between system modules in other embodiments, and functionality of one or more modules may be combined. In general, the component modules of system 20 may be provided in one or more computers of a computing system. For example, all modules may be provided in a computer 1 at which a UI 27 is provided for operator input, or modules may be provided in one or more computers/servers to which user computers can connect via a network, where this network may comprise one or more component networks and/or internetworks including the Internet. A UI 27 for user input may be provided at one or more user computers operatively coupled to the system.

System memory 21 may be implemented, in general, by one or memory/storage components associated with one or more computers of system 20. In addition, while knowledge base 34, text corpus 36 and document corpus 40 are represented as single entities in FIG. 2, each of these entities may comprise content collated from, or distributed over, a plurality of information sources, e.g. databases and/or websites, which are accessed by system 20 via a network.

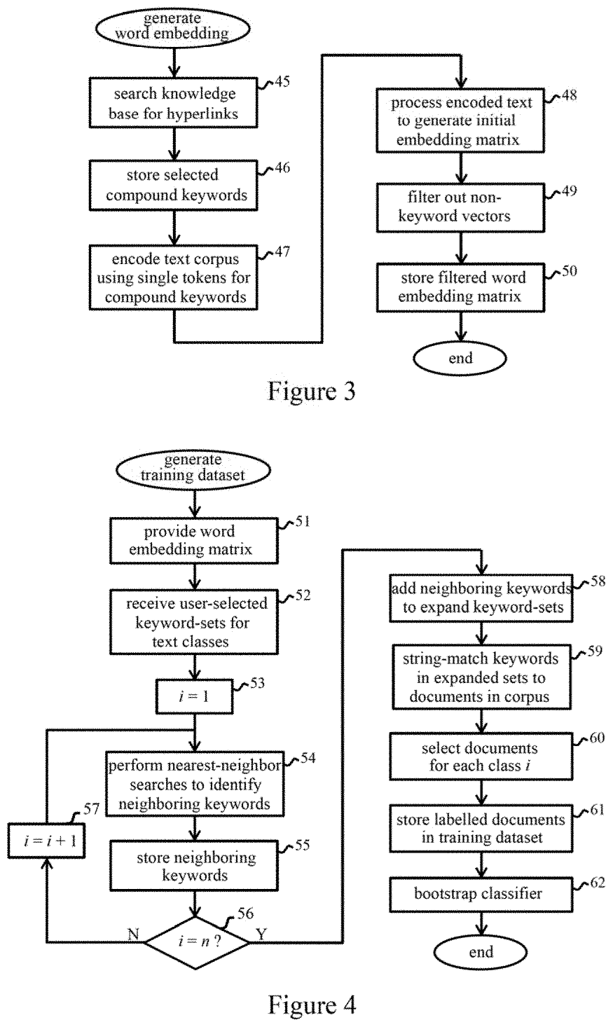

The dataset generation process in system 20 exploits a specialized data structure, i.e. word embedding matrix 37, which is generated in a particular manner via a word embedding scheme. The system 20 of this embodiment is adapted to generate this data structure as a preliminary to the dataset generation process. FIG. 3 indicates steps involved in generating the word embedding matrix. In step 45, the keyword selector module 28 processes content of knowledge base 34 to extract compound keywords associated with hyperlinks in the knowledge base. A knowledge base, such as Wikipedia for instance, is essentially a graph of concepts where the concepts are linked to each other. The keyword selector 28 can extract compound keywords from the knowledge base by looking at the hyperlinks. For example, in the following sentence (in which hyperlinks are signified by underlining): “In thermal power stations, mechanical power is produced by a heat engine which converts thermal energy, from combustion of a fuel, into rotational energy”, the keyword selector may select “heat engine” and “thermal energy”. The hyperlinks in such knowledge bases are manually annotated, and therefore of high quality. By simply scanning the knowledge base text, keyword selector 28 can extract a huge number of well-defined compound keywords for use in the subsequent process. The selected compound keywords 33 are stored in memory 21 as indicated at step 46 of FIG. 3.

In step 47, text encoder 29 processes text corpus 36 to encode words in the text as respective tokens. In this process, any of the selected compound keywords 33 which appear in the text are encoded as respective single tokens. One-hot encoding is conveniently employed here, though other encoding schemes can be envisaged. Each token represents a particular word/keyword, and that word/keyword is replaced by the corresponding token wherever it appears in the text. Tokens are thus effectively word/keyword identifiers. While every word may be encoded in this process, in preferred embodiments text encoder 29 preprocesses the text to remove stop words (such as “a”, “and”, “was”, etc.,) to reduce complexity of the encoding process, and resulting encoded text, without meaningful loss of context information.

The text corpus 36 may comprise one or more bodies of text. While any text sources may be exploited here, larger and more diverse text corpora will result in higher quality embeddings. By way of example, the text encoder 29 may process archives of on-line news articles, about 20,000 of which are generated every day. Other possibilities include abstracts of scientific papers or patents, etc.

The encoded text 35 generated by text encoder 29 is stored in system memory 21. Word embedding module 30 then processes the encoded text via a word embedding scheme to generate the word embedding matrix 37. Word embedding schemes are well-known, and essentially generate a mapping between tokens/words and vectors of real numbers which define locations of respective tokens/words in a multidimensional embedding space. The relative locations of tokens in this space is indicative of the degree of relationship between the corresponding words. In the present case, the relative locations of tokens for compound keywords indicates how related keywords are to one another, with tokens/keywords which are “closer” in the embedding space being more closely related than those which are further apart. A variety of word embedding schemes may be employed here, such as the well-known Glove (Global Vectors) and Word2Vec algorithms for example. In this preferred embodiment, in step 48 of FIG. 3, embedding module 30 first processes the encoded text to generate an initial embedding matrix. This initial matrix includes a vector corresponding to each token in encoded text 35. In step 49, module 30 then filters this initial matrix by removing vectors which do not correspond to tokens for compound keywords 33. The resulting, filtered word embedding matrix 37 is stored in system memory 21 as indicated at step 50.

FIG. 4 indicates steps of the dataset generation process in system 20. Step 51 represents provision in system memory 21 of the word embedding matrix 37 described above. In step 52, the keyword search module 31 prompts for user input via UI 27 of a set of compound keywords which are associated with each text class to be classified by classifier 23. Search module 31 may assist the user in this process, via a specially adapted GUI, as described in more detail below. The user-selected keyword sets (K₁ to Kₙ) 38 are stored in system memory 21. In step 53, search module 31 initiates a loop counter i for the n classes to i=1. In step 54, search module 31 performs, for each keyword in the first keyword-set K₁, a nearest neighbor search of the embedding space defined by word embedding matrix 37 to identify neighboring keywords. This search process is described in more derail below. The neighboring keywords located for keywords in the current set are stored in system memory in step 55. If i<n (decision “No” (N) at decision step 56), the loop counter is incremented in step 57 and steps 54 and 55 are repeated for the next keyword set Kᵢ. The search process thus iterates until the last keyword set Kₙ has been searched (decision “Yes” (Y) at decision step 56).

In step 58, the search module 31 expands the keyword-sets K₁ to Kₙ by adding, to each set, a plurality of the neighboring keywords stored in step 55 for that set. All neighboring keywords might be added to a keyword-set in some embodiments. In this preferred embodiment, however, search module 31 checks whether any neighboring keyword stored in step 55 was identified for more than one keyword-set K₁ to Kₙ. Any such keyword is excluded, and all remaining neighboring keywords are added to their respective keyword-sets K₁ to Kₙ in step 58.

The expanded keyword sets K₁ to Kₙ are used by document matcher module 32 to identify relevant documents in document corpus 40. In step 59, the document matcher 32 string-matches keywords in the keyword-sets to text in each document. In step 60, the document matcher selects documents which are associated with each text class i based on results of the string-matching process. This process is described in more detail below. In step 61, the documents so identified for each text class are stored, with their class label i, in training dataset 39. The resulting training dataset 39 can be used to bootstrap classifier module 23 as indicated at step 62. Training module 25 of ML system 24 can use the dataset to train model 23 via a supervised learning process in the usual way.

It will be seen that the above system exploits a word embedding generated for compound keywords to generate a training dataset automatically with only minimal user input. The compound keywords carry less ambiguity than ordinary words, and exploiting a word embedding based on these keywords enables expanded keyword sets, each collectively descriptive of a class, to be generated automatically and used to extract text about a specific topic with high precision. A training dataset of sufficiently high quality for initial model training can thus be generated with ease, using only a small, easily obtainable set of user-selected keywords per class. This system offers effective automation of a process which previously required significant manual effort by experts in the field in question, allowing classifiers to be trained even when no ground truth data is available. Classifiers can be instantiated quickly, and valuable feedback obtained from model users at an early stage of deployment.

Excluding neighboring keywords identified for more than one class from the expanded keyword sets ensures that potentially non-discriminative keywords are not used in the document matching process, providing well-defined, distinct classes for the training process. Filtering the word embedding matrix in step 49 of FIG. 3 reduces complexity of subsequent processing stages while retaining the benefit of context information from other words in generating the embedding. Alternative embodiments may, however, retain all vectors in the embedding matrix.

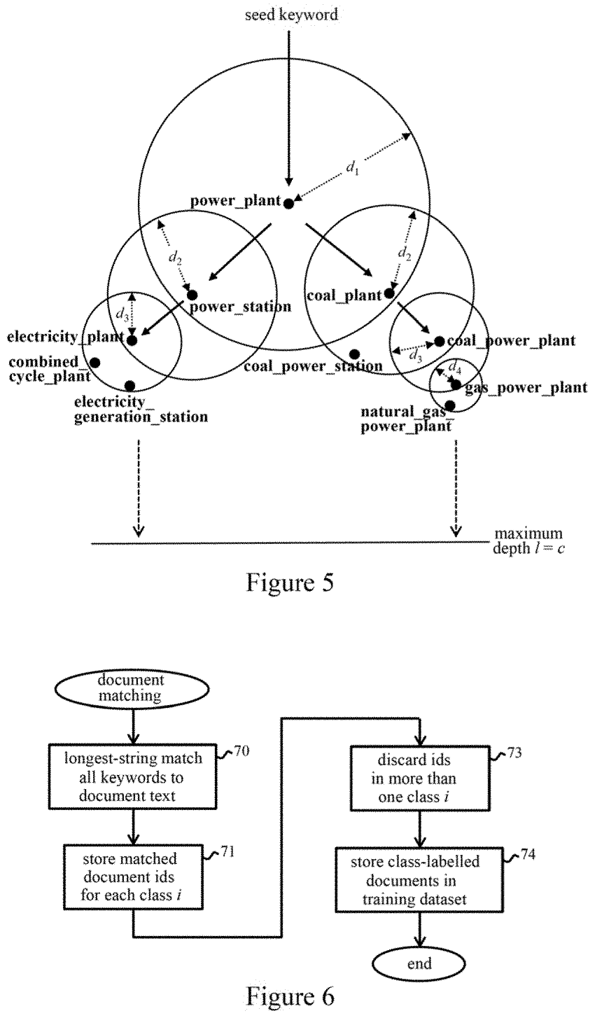

A preferred embodiment of the search process (step 54 of FIG. 4) will now be described in more detail. In this embodiment, the nearest neighbor search for each keyword comprises a breadth-first k-nearest neighbor search over a dynamically generated graph. This graph is generated by locating k neighboring tokens in the embedding space to the token corresponding to the user-selected, “seed” keyword, and iteratively locating neighboring tokens to each token so located. The neighboring keywords for the seed keyword comprise keywords corresponding to tokens so located within a predefined scope for the search. FIG. 5 illustrates this process for a simple example in which the user provides a keyword “power_plant” in the keyword-set for a class “Energy”. In this example, the search scope is limited to a predefined maximum depth c in the graph and specifies a predefined maximum distance in the embedding space for locating neighboring tokens. The maximum distance d1 is specified per level 1 in the graph here. These distances d₁ is indicated by diameters of the circles in FIG. 5. In this example, the number k of neighbors to be considered is set to k=2 for all levels in the graph.

In the first level 1=1 of the graph, two neighboring keywords “coal_plant” and “power_station” are found to be nearest to the seed keyword “power_plant” and within the maximum distance d₁. To identify the nearest neighbors, the “distance” been two keywords is computed here as the cosine similarity between the two vectors in matrix 37 which define the locations of the keyword tokens in the embedding space. This yields a value in the range+1 (angle=0°) to −1 (angle=180°) and can be computed as the dot product of two vectors normalized to have a length of 1. To avoid vector normalization during each search, all vectors in embedding matrix 37 are preferably normalized when the embedding matrix is loaded to system memory 21.

In level 2 of the graph, “coal_plant” leads to two nearest neighbors, “coal_power_station” and “coal_power_plant” within distance d₂ of “coal_plant”. “Coal_power_plant” has a single nearest neighbor, “gas_power_plant”, within distance d₃ in level 3, and this in turn leads to “natural_gas_power_plant” in level 4. Similarly, “power station” in level 1 leads to “electricity plant” in level 2 which in turn leads to “electricity_generation_plant” and “combined_cycle_plant” in level 3. The search process continues up to level 1=c defining the maximum depth in the graph for the search.

The parameters k, d₁ and c are used to control the search of the embedding space and steer the drift between the located neighbors and the original seed keyword. Controlling the drift is a trade-off between precision and recall. If the discovered keywords are semantically very close to the original seed, then the set-augmentation process will be more precise, but the resulting training dataset will have less diversity (and so the resulting classifier may not generalize). The maximum distance parameter is used to limit deviation from the original semantic meaning of the seed during the walk of the graph. Defining the distance d1 per level here, with decreasing value for increasing depth 1, accommodates the increased risk of falling off the original sematic meaning with increasing depth in the graph. While the number k of neighbors to be considered might be similarly reduced for increased depth in the graph, better results are obtained with k fixed, and small (preferably k<10). The maximum depth c limits the overall number of neighbors located. However, the deeper the visit to the graph the higher is the likelihood of drifting from the original seed meaning. In preferred embodiments, therefore, the maximum depth may be restricted to the range c≤3.

Appropriate values for the search parameters can be determined based on various factors such as the particular class, the scope of the word embedding space, and the final goal of model users (precision versus recall). Various other parameters may be used to control the search scope in some embodiments. By way of example, a maximum depth may be defined as an overall distance from the original seed keyword. Clustering information may be also used to further restrict the search scope. Search module 31 may cluster tokens in the embedding space via a clustering process using well-known clustering algorithms such as k-means or dbscan. The predefined search scope for each keyword may then include a restriction to tokens in the same cluster as the token corresponding to that keyword. In some embodiments, search module 31 may use information from external sources, such as Wikipedia disambiguation pages, to limit drift during the search. For example, “diamond ring” may refer to a type of jewelry but also to the “diamond ring” effect which is a feature of total solar eclipses. Wikipedia disambiguation pages capture some of those ambiguous keywords and, when a disambiguation page is available for a specific keyword, that keyword can be easily filtered out by search module 31. Also, since the output of the overall search process is a set of keywords for each class, in some embodiments the search module may display these keywords in UI 27 for manual inspection and deletion of any keywords deemed inappropriate to a class.

FIG. 6 indicates steps of the document matching process in a preferred embodiment. In step 70, document matcher 32 performs, for each keyword in each expanded keyword set, a longest-string search though all documents in document corpus 40. If any keyword in the keyword set for a given class i is longest string matched to text in any document, then the document id (identifier) is stored under the class label i in step 71. Longest-string matching, which requires the whole compound keyword to be found in the searched text, ensures maximum specificity in the matching process.

The document corpus 40 may comprise one or more sets of documents (where a document may be any sample/item of text), such as web-archives for news items, research papers, etc., which can be selected as desired for a particular classification task. In this preferred embodiment, document matcher 32 searches through millions of titles of news items from a range of news websites. On completion of the search, in step 72 the document matcher examines the id-sets stored in step 71 to check for any document ids which were stored for more than one class. Any such document id is deleted from all sets. In step 73, the document matcher then retrieves documents, here news items, corresponding to the remaining document ids from corpus 40, and stores these, along with their corresponding class label i, in training dataset 39. The resulting training dataset 39 thus contains a set of labelled documents for each text class to be classified. Step 73 of this process ensures that a document is only assigned to a given class if no keyword in a keyword-set associated with another class is longest-string matched to the searched text in that document. This excludes non-discriminative documents from the training dataset, improving accuracy of the resulting classifier.

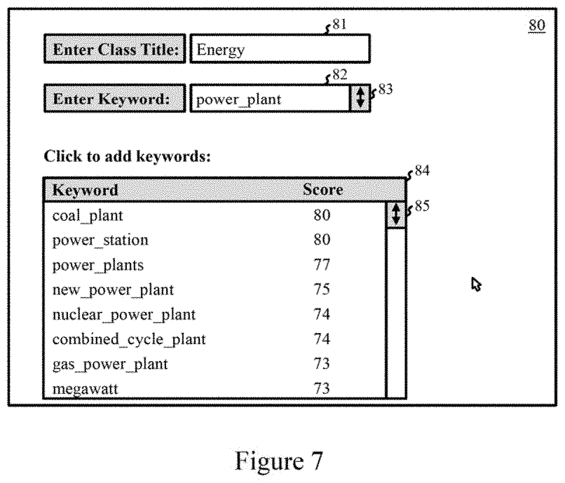

FIG. 7 illustrates key features of a GUI provided at user interface 27 in a preferred embodiment. The GUI 80 provides a window 81 for user input of a class name, here “Energy”, and a window 82 for input of a first compound keyword for the class. Search module 31 may assist the user with keyword entry in window 82, e.g. using predictive text to match user input to keywords 33, and/or by providing a scrollbar 83 to display keywords alphabetically. When the user inputs a keyword in window 82, search module 31 retrieves from the embedding space a plurality of tokens which are closest to the token corresponding to the input keyword. The keywords corresponding to the retrieved tokens are then displayed as a list in window 84. Keywords are displayed here along with a “score” which indicates how close each keyword is, on a scale of 1 to 100, to the keyword in window 81. A scroll bar 85 allows the user to view additional keywords in the list. The user can click on keywords in window 84 to select additional keywords to be added to the keyword set and may repeat the search process for additional keywords in window 82 if desired. The process can then be repeated for a new class title entered in window 81.

Using GUI 80, a user can easily provide an initial keyword set (e.g. 20 or 30 keywords) for each class of interest. Input from multiple users via GUIs 80 may also be merged to define the initial keyword sets. These sets then provide the basic class dictionaries which can be expanded by the search process described earlier.

It will be appreciated that numerous changes and modifications can be made to the exemplary embodiments described above. By way of example, keyword selector 28 may alternatively (or additionally) select compound keywords from on-line glossaries which are available for many domains (e.g. https://www.healthcare.gov/glossary/). Users may eventually compile dictionaries of compound keywords for their specific domain and make them available to increase the coverage for their domain. In some embodiments, therefore, an appropriate set of compound keywords 33 may be provided for system operation, and keyword selector functionality may be omitted. As a further example, distance metrics other than cosine similarity, e.g. Euclidean distance, may be used to measure distance between vectors in the embedding space.

Steps of flow diagrams may be implemented in a different order to that shown, and some steps may be performed in parallel where appropriate. In general, where features are described herein with reference to a method embodying the invention, corresponding features may be provided in a system/computer program product embodying the invention, and vice versa.

The descriptions of the various embodiments of the present invention have been presented for purposes of illustration but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

Based on the foregoing, a computer system, method, and computer program product have been disclosed. However, numerous modifications and substitutions can be made without deviating from the scope of the present invention. Therefore, the present invention has been disclosed by way of example and not limitation.

While the invention has been shown and described with reference to certain exemplary embodiments thereof, it will be understood by those skilled in the art that various changes in form and details may be made therein without departing from the spirit and scope of the present invention as defined by the appended claims and their equivalents.

The descriptions of the various embodiments of the present invention have been presented for purposes of illustration but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the one or more embodiment, the practical application or technical improvement over technologies found in the marketplace, or to enable others of ordinary skill in the art to understand the embodiments disclosed herein.

What is claimed is:

1. A computer-implemented method for generating a training dataset for bootstrapping a text classifier, the method comprising:
providing a word embedding matrix generated from a text corpus by encoding words in the text as respective tokens such that selected compound keywords in the text are encoded as single tokens, and processing the encoded text via a word embedding scheme to generate said word embedding matrix comprising a set of vectors each indicating location of a said token in an embedding space;
receiving, via a user interface, a user-selected set of said keywords associated with each text class to be classified by a text classifier;
for each keyword-set, performing a nearest neighbor search of the embedding space for each keyword in the set to identify neighboring keywords, and adding a plurality of the neighboring keywords to the keyword-set;
for a corpus of documents, string-matching keywords in the keyword-sets to text in each document to identify, based on results of the string-matching, documents associated with each said text class; and
storing the documents identified for each text class as a training dataset.

2. The method as claimed in claim 1 including generating said word embedding matrix from said text corpus and storing the word embedding matrix.

3. The method as claimed in claim 2 including, when processing the encoded text via said word embedding scheme:
generating an initial embedding matrix which includes a vector corresponding to each said token; and
generating said word embedding matrix from the initial embedding matrix by removing vectors which do not correspond to tokens for said compound keywords.

4. The method as claimed in claim 2 including obtaining said selected compound keywords by processing a knowledge base to extract compound keywords associated with hyperlinks in the knowledge base.

5. The method as claimed in claim 1 wherein said nearest neighbor search for each said keyword comprises a breadth-first k-nearest neighbor search over a graph generated by locating k neighboring tokens in the embedding space to the token corresponding to that keyword and iteratively locating neighboring tokens to each token so located, wherein said neighboring keywords comprise keywords corresponding to tokens so located within a predefined scope for the search.

6. The method as claimed in claim 5 wherein said predefined scope of the search for each said keyword comprises at least one of a predefined maximum depth in said graph and a predefined maximum distance in the embedding space for locating neighboring tokens.

7. The method as claimed in claim 6 including clustering tokens in the embedding space, wherein said predefined scope of the search for each keyword includes a restriction to tokens in the same cluster as the token corresponding to that keyword.

8. The method as claimed in claim 5 wherein any neighboring keyword which is identified for more than one keyword-set is excluded from the keywords added to the keyword-sets.

9. The method as claimed in claim 5 wherein k is fixed for each iteration of locating neighboring tokens.

10. The method as claimed in claim 1 including:
providing a graphical user interface for input of the user-selected set of keywords;
in response to input, via said interface, of a said keyword, retrieving from the embedding space a plurality of tokens which are closest to the token corresponding to the input keyword;
displaying in the interface a list of keywords corresponding to the retrieved tokens for user-selection of keywords from the list; and
storing the user-selected set of keywords.

11. The method as claimed in claim 1 including identifying a said document as associated with a said text class if:
any of the keywords in the keyword-set associated with that class are longest-string matched to said text in the document; and
no keyword in a keyword-set associated with another class is longest-string matched to said text in the document.

12. The method as claimed in claim 1 including, after generating said training dataset, using the dataset to train a text classifier model via a supervised learning process.

13. A computer program product for generating a training dataset for bootstrapping a text classifier, the computer program product comprising a computer readable storage medium having program instructions embodied therein, the program instructions being executable by a processing apparatus to cause the processing apparatus to:
store a word embedding matrix generated from a text corpus by encoding words in the text as respective tokens such that selected compound keywords in the text are encoded as single tokens, and processing the encoded text via a word embedding scheme to generate said word embedding matrix comprising a set of vectors each indicating location of a said token in an embedding space;
receive, via a user interface, a user-selected set of said keywords associated with each text class to be classified by said classifier;
for each keyword-set, perform a nearest neighbor search of the embedding space for each keyword in the set to identify neighboring keywords, and add a plurality of the neighboring keywords to the keyword-set;
for a corpus of documents, string-match keywords in the keyword-sets to text in each document to identify, based on results of the string-matching, documents associated with each said text class; and
store the documents identified for each text class as said training dataset.

14. The computer program product as claimed in claim 13 wherein said program instructions are further adapted to generate said word embedding matrix from the text corpus.

15. The computer program product as claimed in claim 14 wherein said program instructions are further adapted, when processing the encoded text via said word embedding scheme, to:
generate an initial embedding matrix which includes a vector corresponding to each said token; and
generate said word embedding matrix from the initial embedding matrix by removing vectors which do not correspond to tokens for said compound keywords.

16. The computer program product as claimed in claim 13 wherein said program instructions are adapted such that said nearest neighbor search for each said keyword comprises a breadth-first k-nearest neighbor search over a graph generated by locating k neighboring tokens in the embedding space to the token corresponding to that keyword and iteratively locating neighboring tokens to each token so located, wherein said neighboring keywords comprise keywords corresponding to tokens so located within a predefined scope for the search.

17. The computer program product as claimed in claim 16 wherein said program instructions are adapted such that said predefined scope of the search for each said keyword comprises at least one of a predefined maximum depth in said graph and a predefined maximum distance in the embedding space for locating neighboring tokens.

18. The computer program product as claimed in claim 16 wherein said program instructions are adapted such that any neighboring keyword which is identified for more than one keyword-set is excluded from the keywords added to the keyword-sets.

19. A computer program product as claimed in claim 13 wherein said program instructions are adapted to identify a said document as associated with a said text class if:
any of the keywords in the keyword-set associated with that class are longest-string matched to said text in the document; and
no keyword in a keyword-set associated with another class is longest-string matched to said text in the document.

20. A system for generating a training dataset for bootstrapping a text classifier, the system comprising:
memory storing a word embedding matrix generated from a text corpus by encoding words in the text as respective tokens such that selected compound keywords in the text are encoded as single tokens, and processing the encoded text via a word embedding scheme to generate said word embedding matrix comprising a set of vectors each indicating location of a said token in an embedding space; and
control logic adapted to receive via a user interface a user-selected set of said keywords associated with each text class to be classified by said classifier, and, for each keyword-set, to perform a nearest neighbor search of the embedding space for each keyword in the set to identify neighboring keywords and to add a plurality of the neighboring keywords to the keyword-set;
wherein the control logic is further adapted, for a corpus of documents, to string-match keywords in the keyword-sets to text in each document to identify, based on results of the string-matching, documents associated with each said text class, and to store in said memory the documents identified for each text class as said training dataset.
